(19) United States
(12) Patent Application Publication
(10) Pub. No.: US 2004/0163032 A1
(43) Pub. Date: Aug. 19, 2004

(54) Ambiguity resolution for predictive text entry

(76) Inventors: Jin Guo, Sunnyvale, CA (US); Charles Yimin Wu, Palo Alto, CA (US); Carlos Isak Mcevilly, Redwood City, CA (US)

Correspondence Address: MOTOROLA INC, 600 NORTH US HIGHWAY 45, ROOM AS437, LIBERTYVILLE, IL, 60048-5343, US

(21) Appl. No.: 10/322,115

(22) Filed: Dec. 17, 2002

(51) Int. Cl. G06F 17/00

(52) U.S. Cl. 715/500; 358/1.18

(57) ABSTRACT

The invention is a method for resolving ambiguity of predictive text entry, such as one used by a portable electronic device (100). A user interface of the portable electronic device (100) includes a processor (206) and an output device (208, 210). The processor (206) is configured to receive the first and second data inputs (304, 312, 404, 412) and determine a word pair corresponding to the first and second data inputs (320, 426). The first data input is associated with a first word and the second data input is associated with a second word. However, the second data input may also be associated with words other than the second word. Thus, the processor (206) identifies possible combinations of word pairs based on the first word and the candidates for the second word (318, 420) and, then, determines the intended word pair from these possible combinations (320, 426). Thereafter, the output device (208, 210) displays the intended word pair determined by the processor (206) (322, 428).

### FIELD OF THE INVENTION

The present invention relates to the field of text entry systems that provide convenient and accurate processes for character input. More particularly, the present invention relates to a text entry system having ambiguity resolution capabilities that maximize the accuracy of the predictive text entry.

### BACKGROUND OF THE INVENTION

Developers of portable electronic devices must implement user interfaces having a limited number of keys. Such developers have struggled with designing user interfaces for data entry of text, such as Roman characters, phonetic characters, ideographic characters, and strokes of ideographic characters. Portable electronic devices, such as a radiotelephone, typically have only twelve or so keys for entering the numbers “0” through “9” and symbols “*” and “#”. It is quite challenging to design a portable electronic device that permits a user to input the numerous characters of a particular language using the limited number of keys in a standard keypad.

Current predictive text entry systems address many of the challenges of text entry for a standard keypad. For predictive text entry, the user presses a key once for each symbol and the system predicts the character that is being entered by the user. Predictive text entry is preferred because it requires, on average, fewer key presses for the entry of each symbol. However, current predictive text entry systems do not always accurately predict the user's intended text and, thus, an improved text entry system with better word prediction and ambiguity resolution is desirable.

### BRIEF DESCRIPTION OF THE DRAWINGS

FIG. 1 is a perspective view of a portable electronic device in accordance with the present invention.

FIG. 2 is a block diagram of internal components of the portable electronic device of FIG. 1.

FIG. 3 is a flow diagram of a preferred operation of the internal components of FIG. 2.

FIG. 4 is a flow diagram of another preferred operation of the internal components of FIG. 2.

### DETAILED DESCRIPTION OF THE PREFERRED EMBODIMENTS

The present invention is a user interface of a portable electronic device that provides for data entry of Roman, phonetic and ideographic characters as well as strokes of ideographic characters. The preferred embodiments, as shown in the drawings and described herein, are directed to a radiotelephone for wireless communication of voice and/or data signals and provides for data entry of Roman, phonetic and ideographic characters. However, it is to be understood that the present invention may be used for any type of portable electronic device such as, but not limited to, paging devices, computers, handheld devices, personal digital assistants, and the like.

In particular, there is described herein a method for resolving ambiguity of predictive text entry. A first data input associated with elements of a first word is received. The first word may be determined from the first data input, and a completion signal that distinguishes the first data input from any subsequent data input may be detected. A second data input, subsequent to the first data input, associated with elements of a second word is then received. Two or more second word candidates may be determined from the second data input. Also, possible combinations of word pairs based on the first word and the second word candidates may be identified. Thereafter, a word pair corresponding the first and second words is determined based on the first and second data inputs. The word pair may be the one having the highest frequency of occurrence.

There is also described a portable electronic device as well as a user interface for the device. The portable electronic device comprises an output device, a processor, an input device, and a transceiver, in which the user interface comprises the output device and at least a portion of the processor's capabilities. The input device is configured to generate first and second data inputs associated with elements of first and second words, respectively. The processor is coupled to the output device, the input device and the transceiver. The processor is configured to receive the first and second data inputs and determine a word pair corresponding to the first and second words based on the first and second data inputs. The output device then displays the word pair provided by the processor, and the transceiver is configured to transmit a message that includes the word pair to a remote device.

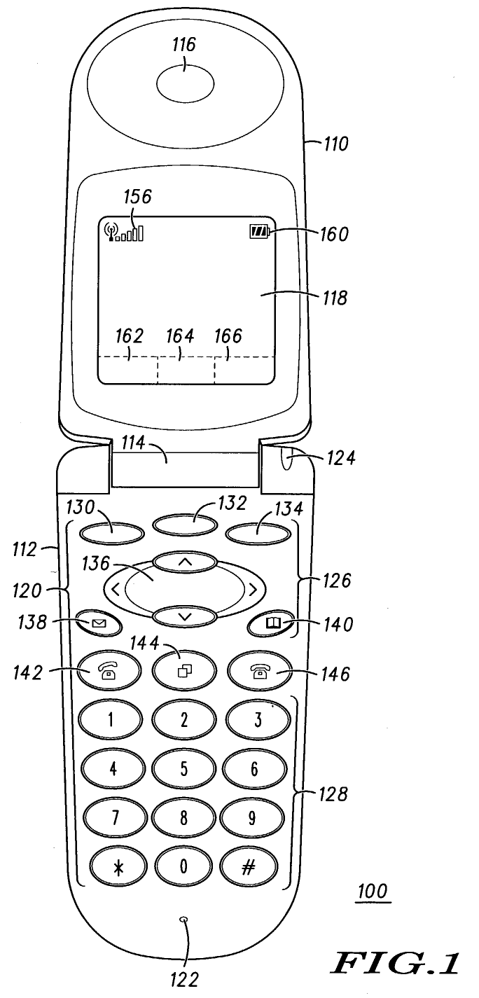

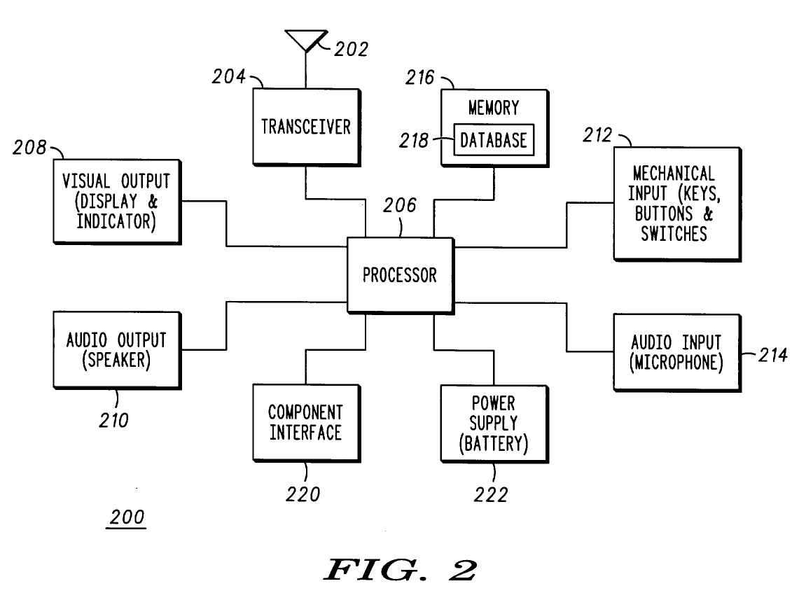

Referring to FIG. 1, there is shown a foldable, portable electronic device 100 having a top section 110 and a bottom section 112 movably joined at a joint section 114. The top section 110 includes an earpiece aperture 116 and a display 118, the bottom section 112 includes a user input 120, a microphone aperture 122, and a visual indicator 124. The device 100 also includes other components of a radiotelephone (shown in FIG. 2) as described below, such as an antenna, power supply, external connectors, additional controls, and the like.

The user input 120 of the present invention includes function keys 126 and data entry keys 128. For the device 100 shown in FIG. 1, the function keys 126 are located at an upper portion of the bottom section 112 and include menu selection keys 130, 132, 134, directional keys 136 (i.e., up, down, left and right), a message retrieval key 138, a memory key 140, a call answer key 142, a clear function key 144, and a call termination key 146. The function keys 126 of the present invention are not limited to those provided for the device 100 and may include other programmed or user-programmable control buttons such as volume control keys, voice recording keys, device setup controls, and the like.

The data entry keys 128 of the device 100 are located at a lower portion of the bottom section and include ten numeric keys, namely keys “1” through “9” and “0”, as well as a “*” key and a “#” key for a total of 12 keys. As shown in FIG. 1, the data entry keys comprise a matrix of four rows in which each row includes three keys, similar to a typical telephone keypad. Although not shown in FIG. 1, the data entry keys 128 may also be used to input other types of symbols, such as Roman characters, phonetic characters, ideographic characters, and strokes of characters. Thus, each key may be used to input a number or character, depending upon the input mode of the device. For example, the input mode of the device may be determined by selection of one or more function keys, such as the menu selection keys 130, 132, 134.

The display 118 of the device provides various types of information to the user. Certain indicators are provided for general operation of the device, such as the signal strength indicator 156 and power indicator 160 of the device 100. Other indicators are provided for operation of the menu selection keys 130, 132, 134 of the function keys. For example, as shown by the device 100 in FIG. 1, there are three menu selection keys 130, 132, 134 provided at the top of the upper portion of the bottom section 112. Also, a bottom area of the display 118 is reserved for one to three menu selection indicators 162, 164, 166 that correspond to one or more of the menu selection keys 130, 132, 134.

Referring to FIG. 2, internal components 200 of the portable electronic device 100 are shown. The preferred embodiment includes an antenna 202; a transceiver 204; a processor 206; output devices 208, 210; and input devices 212, 214. Upon reception of wireless signals, the internal components 200 detect the signals through the antenna 202 to producing detected voice and/or data signals. The transceiver 204, coupled to the antenna 202, converts the detected signals into electrical baseband signals and demodulates the electrical baseband signals to recover incoming information, such as voice and/or data, transmitted by the wireless signals. After receiving the incoming information from the transceiver 204, the processor 206 formats the incoming information for output to the output devices 208, 210. Likewise, for transmission of wireless signals, the processor 206 formats outgoing information and conveys it to the transceiver 204 for modulation of a carrier and conversion into modulated signals. The transceiver 204 conveys the modulated signals to the antenna 202 for transmission to a remote transceiver (not shown).

The input and output devices may include a variety of visual, audio and/or motion devices. The output devices may include, but are not limited to, visual outputs 208 (such as liquid crystal displays and light emitting diode indicators), audio outputs 210 (such as speakers, alarms and buzzers), and motion outputs (such as vibrating mechanisms). The input devices may include, but are not limited to, mechanical inputs 212 (such as keyboards, keypads, selection buttons, touch pads, capacitive sensors, motions sensors, and switches), and audio inputs 214 (such as microphones). For example, the top and/or bottom sections 112, 114 of the device 100 may includes a switch that is responsive to movement of the sections relative to each other and actuates one or more functions of the device as a result.

The internal components 200 of the portable electronic device 100 further include a memory portion 216 for storing and retrieving data. The processor 206 may perform various operations to store, manipulate and retrieve information in the memory portion 216. For example, the processor 206 may search the memory 226 for previously stored data by entering search elements or symbols from the user devices 212, 214. During search, the processor 206 compares stored data with the input search elements or symbols. If one or more matches are found, the matched data are provided to the output devices 208, 210 or further processed by the processor 206. For the preferred embodiments, the memory portion 216 stores a word path database 218 that includes a first word field, a second word field and a word pair field corresponding to the first and second word fields. The processor 206 may reference the word path database 218 to determine a word pair corresponding to first and second words based data inputs received from the input devices 212, 214.

The internal components 200 of the portable electronic device 100 may further include a component interface 220 and a power supply 222. Accessories and additional components may be coupled to the component interface 220 to provide additional functionality and capabilities to the device 100. The power supply 222 provides power to the internal components 200 so that they may function correctly, such as a battery.

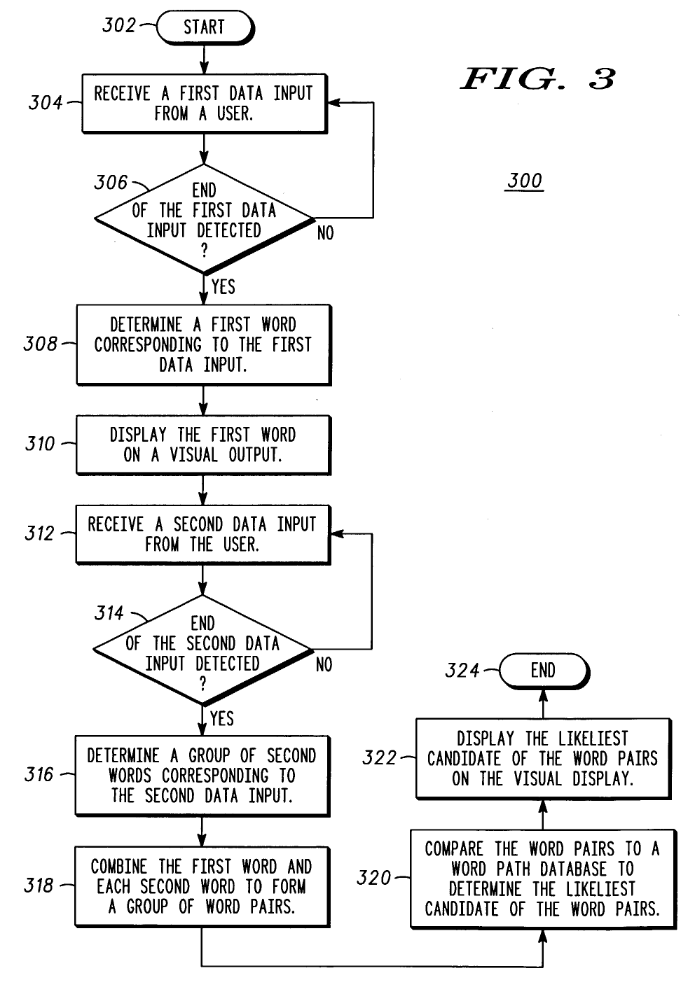

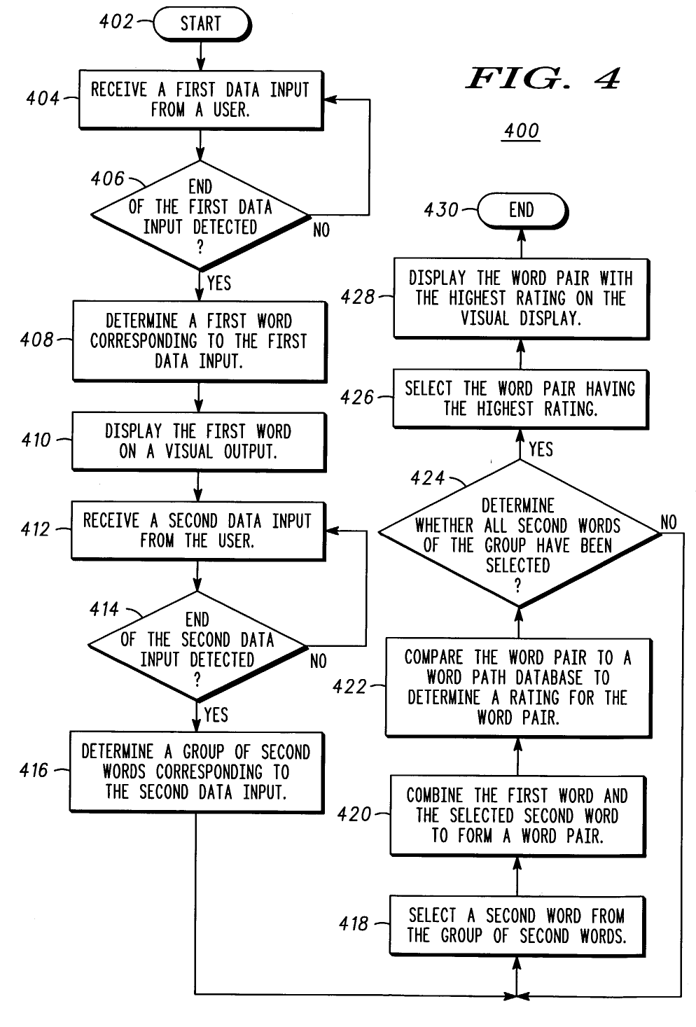

Referring to FIG. 3 in conjunction with FIG. 2, there is provided a first preferred embodiment 300 of the operation of the internal components 200 of the portable electronic device 100. Generally, the operation of the first preferred embodiment 300 is managed by the processor 206 with the support of the other components of the device 100. Before the operation of the first preferred embodiment 300 begins at step 302, a word path database 218 that has various fields must be generated and provided to the memory portion 216 of the device 100. The word path database 218 includes, but is not limited to, a first word field, a second word field and a word pair field that corresponds to the first and second word fields. This word path database 218 will be utilized during the operation of the first preferred embodiment 300 at step 320 as well as a similar step 422 (shown in FIG. 4) during the operation of the second preferred embodiment 400.

The word path database 218 of the preferred embodiments is configured for optimal performance of the processor 206 and minimal storage requirements for the memory portion 216. Although the word path database 218 may include all possible combinations of first words, second words and word pairs, it is desirable to minimize its size in order to maximize processor performance and minimize storage requirements. The ambiguity operation of the device 100 will not be degraded if the word path database 218 only includes second words that are always ambiguous. Second words are always ambiguous if they share the same data input with another word. For example, the key combination of 4-6-6-3 may be associated with the words “good” and “home”. The word path database 218 only needs to include second words that are always ambiguous, since unambiguous words do not require any type of ambiguity resolution. Also, the ambiguity operation of the device 100 will not be degraded if the word path database 218 excludes word pairs that are identified by another database. For example, the ambiguity resolution feature of the present invention may be used in conjunction with other predictive text entry features to maximize accuracy. It is not necessary for features to overlap, so the word path database 218 does not need to include second words or word pairs that are presented by other databases of the device 100.

The operation of the first preferred embodiment 300 initiated at step 302 and, then, the processor 206 receives a first data input from a user via the input devices 212, 214 at step 304. The first data input is associated with elements of a first word and may assume a variety of forms including, but not limited to, a string of Roman characters, a series of phonetic characters, and a series of strokes for an ideographic character. For the first preferred embodiment 300, the input devices 212, 214 are the data entry keys 128 of the portable electronic device 100, but the input devices may also be motion-activated or voice-activated by one of the other mechanical inputs or the audio input. It should be noted that the device 100 of the present invention may utilize incremental input features. For an incremental input feature, the device 100 may perform prediction after each and every character entry, as opposed to performing prediction after a string or series of characters.

Next, the processor 206 detects an end of the first data input at step 306. For the first preferred embodiment 300, the processor 206 detects a completion signal that distinguishes the first data input from any subsequent data input. The end of the first data input may be detected by selection of a particular key, a delay in key entry, a predetermined number of key entries, or an identifiable pattern of key entries. For example, the processor 206 may understand that entry of a predetermined key (such as a “space” key) or a delay of a particular time period (such as a few seconds) between key entries may indicates that the previously entered key is the last key of a string of characters. As another example, a predetermined quantity of key entries (such as five) or an identifiable pattern of key entries (such as a consonant followed by a vowel followed by a consonant) may indicate that the most recently entered key is the last key of a string of characters.

After the processor 206 identifies the first data input as being complete, the processor determines one or more words based on the first data input at step 308. If only one word is determined, then that word becomes identified as the first word. If more than one word is determined, the processor 206 selects the first word from these words based a word frequency database. The word frequency database identifies the frequency in which a word generally occurs for text entry systems and specifically occurs for its associated device. Once the first word is identified, the processor 206 provides the first word to an output device 208, 210, such as a visual display, at step 310. If more than one word based on the first data input was identified at step 308, then the first word may be accompanied by the other words.

Subsequent to the first data input, the processor 206 receives a second data input that is associated with elements of a second word at step 312 and, similar to the first word, may assume a variety of forms and receive input from a variety of input devices 212, 214 as described above. Preferably, the second word has the same form as the first word. Next, the processor 206 detects an end of the second data input at step 314. The processor 206 may detects another completion signal that distinguishes the second data input from any subsequent data input and indicates that entry of the second data input has been completed. Similar to the first data input, the end of the second data input may be detected by a variety of methods as described above. However, the processor 206 may also detect partial words and, thus, one should not assume that the completion signal only identifies complete words.

The processor 206 then determines two or more second words based on the second data input at step 316. The user of the portable electronic device 100 may have intended to enter a particular second word but, since the actual entry is a more ambiguous second data input, the second data input may be associated with words other than the second word intended by the user. Thus, the processor 206 identifies possible combinations of word pairs based on the first word and the candidates for the second word at step 318 and, then, determines the intended word pair from these possible combinations at step 320. For the first preferred embodiment 300, the processor 206 combines the first word with each word of the group of second words to form a group of candidate word pairs. Also, for the first preferred embodiment, the processor 206 compares the candidate word pairs to the word pair database 218 to determine the likeliest candidate of the word pairs. In particular, the processor 206 may lookup each candidate word pair, determine the frequency of occurrence of each candidate word pair, and select the candidate word pair having the most occurrences (in general, for the associated device, or both) to be the likeliest candidate of the word pairs.

For example, the processor 206 may determine that the first word is the word “go” and the second word, based on the key combination 4-6-6-3, may be “good”, “home”, “gone”, “hood”, “goof”, “hone”, “hoof”, “homo”, “imme”, “inne”, “innd”, “innf” and “inn3”. It is important to note that the last six candidates for the second word are not complete words, but they represent the first four characters of other possible words that are longer than four characters, i.e. partial words. Accordingly, the second words, as identified for the present invention, may be partial words and should not be interpreted to be restricted to complete words. For this example, the processor 206 would form the following candidate word pairs: “go good”, “go home”, “go gone”, “go hood”, “go goof”, “go hone”, “go hoof”, “go homo”, “go imme”, “go inne”, “go innd”, “go innf” and “go inn3” at step 318. Then, at step 320, the processor 206 would compare these candidate word pairs to the word path database 218 to determine that the likeliest candidate of the word pairs is “go home”. In particular, the word pair “go home” occurs more frequently than any combination of words. Without this feature of the present invention, the processor 206 may instead select the word “good” to follow the word “go” since the word “good” may occur more frequently than any other word corresponding to the key combination of 4-6-6-3.

Finally, the processor 206 provides the second word to an output device 208, 210 at step 322, and the operation is terminated at step 324. For the first preferred embodiment 300, the second word is provided by the output device 208, 210 adjacent to the first word so that the second word appears to follow the first word.

Referring to FIG. 4 (in conjunction with FIG. 2), there is provided a second preferred embodiment 400 of the operation of the internal components 200 of the portable electronic device 100. The operation of the second preferred embodiment 400 compares each word pair to the word pair database 218 as each word pair is identified, in contrast to the operation of the first preferred embodiment in which all word pairs are identified before any word pair is compared to the word pair database. Steps 402 through 416 of the second preferred embodiment 400 are substantially similar to steps 302 through 316 of the first preferred embodiment and, thus, the above description for steps 302 through 316 applies for steps 402 through 416. The remainder of the operation of the second preferred embodiment 400 is provided below.

For the second preferred embodiment 400, at step 418, the processor 206 selects a candidate second word from the group of second words determined at the previous step, i.e., step 416. Next, the processor 206 combines the first word and the selected second word to form a word pair at step 420. The processor 206 then compares the word pair to the word pair database 218 to determine a rating for the word pair at step 422. Thus, in addition to a first word field, a second word field and a word pair field corresponding to the first and second word fields, the word pair database 218 of the second preferred embodiment includes a rating for each word pair. For the second preferred embodiment, the rating for each word pair of the possible combinations is based on frequency of occurrence (in general, for the associated device, or both). In this manner, a rating is assigned to each word pair of the candidate word pairs by executing steps 418 through 424 until all second words of the group have been selected. After a rating is assigned to each word pair, the processor 206 selects the candidate word pair having the highest rating among the possible combinations of word pairs at step 426.

Finally, the processor 206 provides the selected second word to an output device 208, 210 at step 428, and the operation is terminated at step 430. For the second preferred embodiment 400, the second word is provided by the output device 208, 210 adjacent to the first word so that the second word appears to follow the first word. In the alternative, the word pairs of the possible combinations may be sequentially ordered based on their ratings so that they may be provided by the output device in that particular order.

While the preferred embodiments of the invention have been illustrated and described, it is to be understood that the invention is not so limited. For example, although the first and second preferred embodiments described above, combine and select words, the present invention may also operate effectively by combining and/or selecting data inputs. Also, although the first word must be complete word, the present invention may operate effectively when the second word is either a complete word or a partial word. Numerous modifications, changes, variations, substitutions and equivalents will occur to those skilled in the art without departing from the spirit and scope of the present invention as defined by the appended claims.

What is claimed is:

1. A method for resolving ambiguity of predictive text entry comprising the steps of:
receiving a first data input associated with elements of a first word;
detecting a completion signal that distinguishes the first data input from any subsequent data input;
receiving a second data input, subsequent to the first data input, associated with elements of a second word;
determining a word pair corresponding the first and second words based on the first and second data inputs.

2. The method of claim 1, further comprising the step of detecting another completion signal indicating that entry of the second data input has been completed.

3. The method of claim 1, further comprising the step of providing the second word to an output device adjacent to the first word, after the step of determining the word pair.

4. A method for resolving ambiguity of predictive text entry comprising the steps of:
receiving a first data input;
determining a first word based on the first data input;
receiving a second data input;
determining a plurality of second words based on the second data input;
identifying possible combinations of word pairs based on the first word and the plurality of second words; and
determining a particular word pair of the possible combinations having the highest frequency of occurrence.

5. The method of claim 4, further comprising the step of rating for each word pair of the possible combinations based on frequency of occurrence.

6. The method of claim 5, wherein the particular word pair is the word pair having the highest rating among the possible combinations of word pairs.

7. The method of claim 5, further comprising the step of sequentially ordering word pairs of the possible combinations based on their ratings.

8. The method of claim 1, further comprising the step of generating the word path database before the step of receiving the first data input, the word path database including a first word field, a second word field and a word pair field corresponding to the first and second word fields.

9. The method of claim 1, further comprising the step of providing the first word to an output device.

10. The method of claim 9, further comprising the step of providing a second word of the plurality of second words to the output device adjacent to the first word.

11. A user interface for a portable electronic device comprising:
an output device; and
a processor, coupled to the output device, configured to receive first and second data inputs associated with elements of first and second words, respectively, determine a word pair corresponding to the first and second words based on the first and second data inputs, and provide the word pair on the output device.

12. The user interface of claim 11, further comprising a word path database, coupled to the processor, configured to store a plurality of first words, a plurality of second words, and a plurality of word pairs corresponding to the plurality of first words and the plurality of second words.

13. The user interface of claim 12, wherein each second word of the plurality of second words is associated with a data input, the data input being associated with at least one other word.

14. The user interface of claim 12, wherein the word path database excludes word pairs that are identified by another database.

15. The user interface of claim 11, wherein the word pair comprises the first word followed by the second word.

16. The user interface of claim 11, wherein the output device is at least one of a visual output and an audio output.

17. The user interface of claim 11, further comprising a user input, coupled to the processor, for providing the first and second data inputs to the processor.

18. The user interface of claim 17, wherein the user input is at least one of a mechanical input and an audio input.

19. The user interface of claim 11, wherein the processor detects a completion signal that distinguishes the first data input from the second data input.

20. A portable electronic device comprising:
an output device;
a processor, coupled to the output device, configured to receive first and second data inputs associated with elements of first and second words, respectively, determine a word pair corresponding to the first and second words based on the first and second data inputs, and display the word pair on the output device;
an input device, coupled to the processor, configured to generate the first and second data inputs; and
a transceiver, coupled to the processor, configured to transmit a message that includes the word pair to a remote device.

21. The portable electronic device of claim 20, further comprising a word path database, coupled to the processor, configured to store a plurality of first words, a plurality of second words, and a plurality of word pairs corresponding to the plurality of first words and the plurality of second words.

22. The portable electronic device of claim 21, wherein each second word of the plurality of second words is associated with a data input, the data input being associated with at least one other word.

23. The portable electronic device of claim 21, wherein the word path database excludes word pairs that are identified by another database.
